(19) United States
(12) Patent Application Publication
(10) Pub. No.: US 2026/0103020 A1
(43) Pub. Date: Apr. 16, 2026

(54) Universal Aerodynamic Wheel Cover

(71) Applicant: Wheel Pros, LLC, Greenwood Village, CO (US)

(72) Inventors: Tom Van Ryn, Phoenix, AZ (US); Ronald Baugh, Irvine, CA (US); Steven Kern, Irvine, CA (US); Yuri Ranum, Irvine, CA (US)

(73) Assignee: Wheel Pros, LLC, Greenwood Village, CO (US)

(21) Appl. No.: 19/357,451

(22) Filed: Oct. 14, 2025

Related U.S. Application Data
(63) Continuation-in-part of application No. 18/108,418, filed on Feb. 10, 2023.

(51) Int. Cl. B60B 7/14; B60B 7/00; B60B 7/06

(52) U.S. Cl. CPC B60B 7/14; B60B 7/0053; B60B 7/066; B60B 2360/30; B60B 2900/131; B60B 2900/3312; B60B 2900/572

(57) ABSTRACT

An adapter assembly that allows a wheel cover to be attached to a wheel has an inner device which locks through a central hole in the cover to an outer device insert. The inner device removably locks to a vehicle wheel, A The cam trapping cage secures a locking cam to a main wheel mounting clip with prongs that snap over the lip of the cam trapping cage, securing the assembly to the wheel hub centerbore. The locking cam physically blocks the mounting clip to keep them from backing out of their secured position. A silicone o-ring lies between the cover and the wheel lip, keeping the cover under constant tension for secure connection. Outside the cover, a billet hex nut and a hex nut o-ring reduces vibration and connects the cover to the inner device. A cap base with cam safety also prevents the locking cam from backing out.

### CROSS REFERENCE TO RELATED APPLICATIONS

This application claims priority to U.S. Ser. No. 18/108,418, filed Aug. 20, 2025, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of attachment devices, and more specifically to a universal adaptor that can be used to securely attach an aerodynamic wheel cover to an automobile wheel.

### Brief Description of Invention

The present invention is a multi-part assembly that has an insert grips the cap lip of a wheel to secure the device to the wheel, with additional parts to prevent the insert from “unscrewing itself” as the wheel bounces over surface irregularities in the rod.

### Statement of the Problem

Automobile wheels are not perfectly aerodynamic. Wheel covers that are considerably more aerodynamic than the average automobile wheel provide better gas mileage and can be more attractive than the wheel, but are difficult to install and keep from getting stolen. Wheel covers are compatible only with specific base wheels that were intended for that purpose and are either difficult to install and remove or fall off and/or are stolen easily. This system solves this problem by allowing covers to be designed for universal compatibility with multiple different base wheels, including wheels that were never intended for compatibility with a wheel cover.

The current invention provides a solution by having a simple and easy-to-use device that can attach and detach a disc to a vehicle wheel.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### DESCRIPTION OF THE FIGURES

One preferred form of the invention will now be described with reference to the accompanying drawings.

FIG. 1 is an exploded, perspective view of several of the main components of the invention.

### DETAILED DESCRIPTION OF THE FIGURES

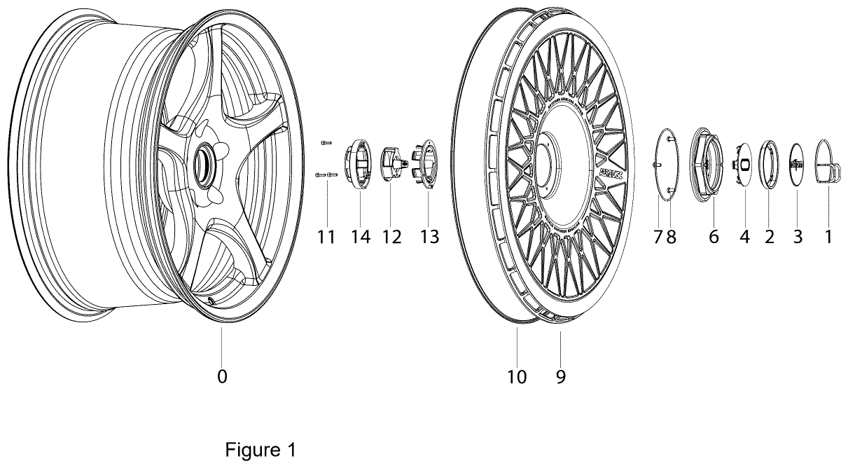

FIG. 1 is an exploded, perspective view of the main components of the invention. The purpose of the invention is to removably secure an Aerodisc (9) to a vehicle wheel (0). The cam trapping cage (14) secures the locking cam (12) in the invention assembly. The main wheel mounting clip (13) utilizes prongs that snap over the lip of the cam trapping cage, securing the assembly to the wheel hub centerbore.

The locking cam (12) physically blocks the mounting clip(s) to keep them from backing out of their secured position. Unit assembly screws (11) fasten the system together. The silicone o-ring (10) lies between the Aerodisc (9) itself and the wheel lip, keeping the Aerodisc (9) under constant tension for a secure connection. The Aerodisc (9) has a central hole which allows the invention components above the hole to attach to the invention components below the hole. Above the hole, the Aerodisc screws and washers (8) attach the Aerodisc (9) to the billet hex nut (6). A hex nut o-ring (7) reduces Aerodisc (9) vibration. Above the hex nut o-ring (7) lies a billet hex nut (6) which connects the Aerodisc (9) and the invention. The cap base with cam safety (4) also prevents the locking cam (12) from backing out due to vibration. The acrylic cap (3) shows the brand name and/or logo and allows for graphic design customization. Above the acrylic cap (3) the cap decorative ring (2) allows for additional customization of the brand aesthetic. Finally a decorative spring (1) snaps into the billet hex nut (6) for optional/additional customization

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for removably attaching a cover to a vehicle wheel, consisting of an inner device and an outer device,
Wherein the inner device is secured to the vehicle wheel, and the outer device removably attached the cover to the inner device through a central hole in the middle of the cover,
where the inner device consists a cam trapping cage which secures a locking cam to a main wheel mounting clip which utilizes a plurality of prongs to snap over a lip of a cam trapping cage, which secures the inner device to a wheel hub centerbore, wherein a locking cam physically blocks a plurality of mounting clip on the main wheel mounting clip to keep them from backing out of their secured position, wherein a plurality of unit assembly screws fasten the various parts of the inner device together,
wherein a silicone O-ring lies between the cover and a wheel lip, keeping the cover under constant tension for a secure connection, wherein the cover has the central hole which allows the inner device to attach to the outer device,
wherein outside of the cover, a plurality of Aerodisc screws and washers attach the cover to a billet hex nut, wherein a hex nut O-ring reduces vibration of the cover, wherein outside of the hex nut O-ring lies a billet hex nut which connects the cover to the inner device and outer device, wherein a cap base with cam safety also prevents the locking cam from backing out due to vibration, wherein an acrylic cap shows the brand name and/or logo and allows for graphic design customization, wherein a cap decorative ring allows for additional customization of the brand aesthetic, wherein a decorative spring snaps into the billet hex nut for optional/additional customization.

2. A device for removably attaching a cover to a vehicle wheel, comprising an inner device and an outer device, wherein the inner device and the outer device removably secure the cover to the vehicle wheel.

3. The device of claim 2, wherein the inner device is secured to the vehicle wheel, and the outer device removably attached the cover to the inner device through a central hole in the middle of the cover.

4. The device of claim 3, wherein the inner device comprises a cam trapping cage which secures a locking cam to a main wheel mounting clip which utilizes a plurality of prongs to snap over a lip of a cam trapping cage, which secures the inner device to a wheel hub centerbore.

5. The device of claim 4, wherein a locking cam physically blocks a plurality of mounting clip on the main wheel mounting clip to keep them from backing out of their secured position.

6. The device of claim 5, wherein a plurality of unit assembly screws fasten the various parts of the inner device together.

7. The device of claim 6, wherein a silicone O-ring lies between the cover and a wheel lip, keeping the cover under constant tension for a secure connection, wherein the cover has the central hole which allows the inner device to attach to the outer device.

8. The device of claim 7, wherein outside of the cover, a plurality of Aerodisc screws and washers attach the cover to a billet hex nut.

9. The device of claim 8, wherein a hex nut O-ring reduces vibration of the cover, wherein outside of the hex nut O-ring lies a billet hex nut which connects the cover to the inner device and outer device.

10. The device of claim 9, wherein a cap base with cam safety also prevents the locking cam from backing out due to vibration.

11. The device of claim 10, wherein an acrylic cap shows the brand name and/or logo and allows for graphic design customization.

12. The device of claim 11, wherein a cap decorative ring allows for additional customization of the brand aesthetic.

13. The device of claim 12, wherein a decorative spring snaps into the billet hex nut for optional/additional customization.

14. A device for removably attaching a cover to a vehicle wheel, comprising an inner device and an outer device, wherein the inner device and the outer device removably secure the cover to the vehicle wheel, wherein the inner device removably attaches to the outer device through a central hole in the cover.

15. The device of claim 14, wherein the inner device attaches to the vehicle wheel and the outer device removably secures the cover to the inner device.

16. The device of claim 15, wherein the inner device comprises a cam trapping cage which secures a locking cam to a main wheel mounting clip which utilizes a plurality of prongs to snap over a lip of a cam trapping cage, which secures the inner device to a wheel hub centerbore, wherein a locking cam physically blocks a plurality of mounting clip on the main wheel mounting clip to keep them from backing out of their secured position, wherein a plurality of unit assembly screws fasten the various parts of the inner device together.

17. The device of claim 15, wherein a silicone O-ring lies between the cover and a wheel lip, keeping the cover under constant tension for a secure connection, wherein the cover has the central hole which allows the inner device to attach to the outer device.

18. The device of claim 15, wherein outside of the cover, a plurality of Aerodisc screws and washers attach the cover to a billet hex nut, wherein a hex nut O-ring reduces vibration of the cover, wherein outside of the hex nut O-ring lies a billet hex nut which connects the cover to the inner device and outer device.

19. The device of claim 18, wherein a cap base with cam safety also prevents the locking cam from backing out due to vibration, wherein an acrylic cap shows the brand name and/or logo and allows for graphic design customization.

20. The device of claim 18, wherein a cap decorative ring allows for additional customization of the brand aesthetic, wherein a decorative spring snaps into the billet hex nut for optional/additional customization.
